(19) United States
(12) Patent Application Publication
(10) Pub. No.: US 2023/0259510 A1
(43) Pub. Date: Aug. 17, 2023

(54) EQUILIBRIUM SOLUTION SEARCHING METHOD AND INFORMATION PROCESSING APPARATUS

(71) Applicant: Fujitsu Limited, Kawasaki-shi (JP)

(72) Inventors: Natsuki ISHIKAWA, Yamato (JP); Masatoshi OGAWA, Zama (JP); Hayato DAN, Yokohama (JP); Katsumi HOMMA, Kawasaki (JP)

(73) Assignee: FUJITSU LIMITED, Kawasaki-shi (JP)

(21) Appl. No.: 18/056,827

(22) Filed: Nov. 18, 2022

(30) Foreign Application Priority Data
Feb. 15, 2022 (JP) 2022-021516

(51) Int. Cl. G06F 16/2455; G06F 16/23

(52) U.S. Cl. CPC G06F 16/2455; G06F 16/23

(57) ABSTRACT

An information processing apparatus generates a data set including a plurality of records each of which indicates one out of a plurality of behaviors. The information processing apparatus calculates a first evaluation value for a first behavior that appears in the data set, based on a distribution of appearance frequency of first behaviors in the data set. The information processing apparatus updates at least a part of the records so that the appearance frequency of a first behavior whose first evaluation value exceeds a threshold increases. The information processing apparatus calculates a second evaluation value for a second behavior that appears in the updated data set based on a distribution of the appearance frequency of second behaviors in the updated data set.

### CROSS-REFERENCE TO RELATED APPLICATION

This application is based upon and claims the benefit of priority of the prior Japanese Patent Application No. 2022-021516, filed on Feb. 15, 2022, the entire contents of which are incorporated herein by reference.

### FIELD

The embodiments discussed herein relate to an equilibrium solution searching method and an information processing apparatus.

### BACKGROUND

In situations where each of a plurality of players stochastically selects one behavior out of a plurality of potential behaviors, an information processing apparatus may search for an equilibrium solution for a probability distribution of the plurality of behaviors. A simulation structure for the above situation is sometimes referred to as “evolutionary game theory”. A plurality of behaviors that are combined according to a certain probability distribution are sometimes referred to as a “mixed strategy”.

As one example, discrete-time replicator dynamics calculates an evaluation value for each of a plurality of behaviors according to a certain probability distribution, increases the probability of behaviors with evaluation values that are larger than the average evaluation value, and decreases the probability of behaviors with evaluation values that are smaller than the average evaluation value. Discrete-time replicator dynamics repeatedly calculates the evaluation values and updates the probability distribution.

An optimization system that uses a genetic algorithm to optimize a product portfolio and a product supply schedule in order to maximize profits has been proposed. A supply chain optimization system with an optimization module, such as a genetic algorithm and linear programming, has also been proposed. A supply plan generation system that uses a genetic algorithm to determine the priorities of jobs in response to various demands has also been proposed. A multi-agent system that performs distributed scheduling using a genetic algorithm has also been proposed.

See, for example, International Publication Pamphlet No. WO 2002-007045, International Publication Pamphlet No. WO 2006-111821, U.S. Pat. Application Publication No. 2011-0173034, and U.S. Pat. Application Publication No. 2011-0224816.

### SUMMARY

According to an aspect, there is provided a non-transitory computer-readable recording medium storing therein a computer program that causes a computer to execute a process including: generating a data set including a plurality of records each of which indicates one out of a plurality of behaviors; calculating a first evaluation value for each of at least two first behaviors, which is included in the plurality of behaviors and appears in the data set, based on a distribution of appearance frequency of the at least two first behaviors in the data set; updating at least a part of the plurality of records included in the data set so as to increase an appearance frequency of a first behavior whose first evaluation value exceeds a threshold; and calculating a second evaluation value for each of at least two second behaviors, which is included in the plurality of behaviors and appears in the updated data set, based on a distribution of appearance frequency of the at least two second behaviors in the updated data set.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 depicts an information processing apparatus according to the first embodiment;

FIG. 2 depicts example hardware of an information processing apparatus according to a second embodiment;

FIG. 3 depicts an example updating of a population by an improved genetic algorithm;

FIG. 4 depicts one example of players in a simulation;

FIG. 5 depicts example strategies and a definition of payoff in a simulation;

FIG. 6 depicts example results of one iteration of a simulation;

FIG. 7 depicts an example of a probability distribution of a mixed strategy after convergence;

FIG. 8 is a graph depicting example changes to the number of strategies whose payoffs are calculated;

FIG. 9 is a block diagram depicting example functions of an information processing apparatus;

FIG. 10 is a flowchart depicting a processing procedure of a search for an equilibrium solution; and

FIG. 11 is a flowchart further depicting a processing procedure of a search for an equilibrium solution.

### DESCRIPTION OF EMBODIMENTS

In a simple implementation of a search for an equilibrium solution, including calculation of evaluation values of a plurality of behaviors and updating of a probability distribution, an information processing apparatus will recalculate the evaluation values of each behavior every time the probability distribution is updated. However, when there are many potential behaviors and/or when a simulation with a high processing load is performed every time evaluation values are calculated, the load of calculating the evaluation values may be high.

Several embodiments will be described below with reference to the accompanying drawings.

### First Embodiment

A first embodiment will now be described.

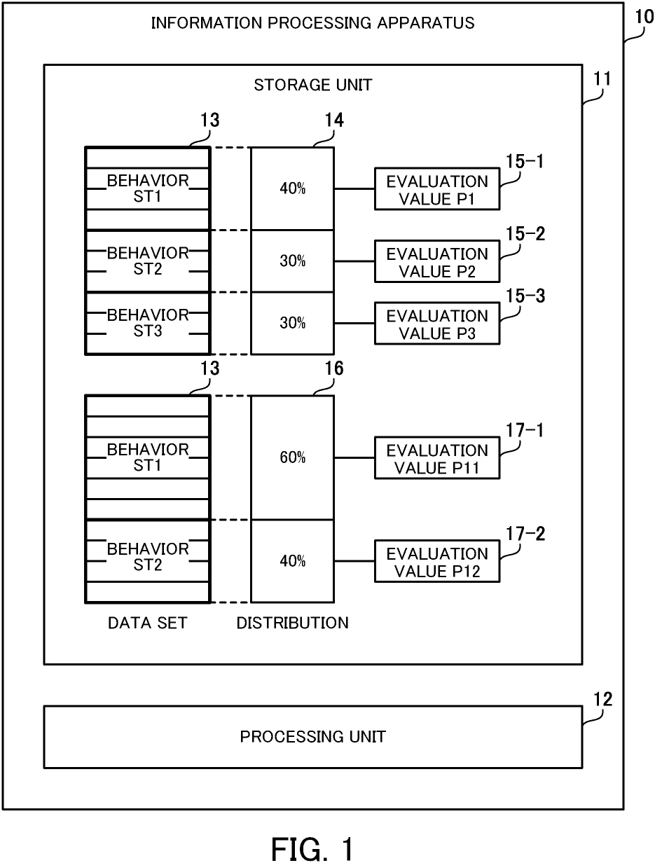

FIG. 1 depicts an information processing apparatus according to the first embodiment.

An information processing apparatus 10 according to the first embodiment searches for an equilibrium solution of a probability distribution for a plurality of behaviors in a situation where each of a plurality of players stochastically selects one behavior out of a plurality of potential behaviors. The search for an equilibrium solution in this first embodiment may incorporate the ideas of a genetic algorithm and discrete-time replicator dynamics. The information processing apparatus 10 may be a client apparatus or a server apparatus. The information processing apparatus 10 may be referred to as a “computer”, an “equilibrium solution searching apparatus”, or a “simulation apparatus”.

The information processing apparatus 10 includes a storage unit 11 and a processing unit 12. The storage unit 11 may be a volatile semiconductor memory, such as a random access memory (RAM), or may be non-volatile storage, such as a hard disk drive (HDD) or flash memory. As examples, the processing unit 12 is a processor such as a central processing unit (CPU), a graphics processing unit (GPU), or a digital signal processor (DSP). The processing unit 12 may include an electronic circuit such as an application specific integrated circuit (ASIC) or a field programmable gate array (FPGA). As one example, the processor executes programs stored in a memory, such as RAM (which may be the storage unit 11). A group of processors may be called a “multiprocessor” or simply a “processor”.

The storage unit 11 stores a data set 13. The data set 13 includes a plurality of records, each of which indicates one of a plurality of potential behaviors of a player. These behaviors may also be referred to as “strategies”. Individual behaviors may be referred to as “pure strategies”, and a plurality of behaviors that have been combined according to a certain probability distribution may be referred to as a “mixed strategy”. Each record may be referred to as an “individual” or a “gene”. The data set 13 may be referred to as a “set of individuals”, a “gene set” or a “population”. Different records may indicate the same behavior. All behaviors do not always appear in the data set 13.

The processing unit 12 calculates an evaluation value for each of two or more behaviors that appears in the data set 13, out of the potential behaviors of the player, based on a distribution 14 of appearance frequency of the behaviors in the data set 13. This evaluation value may be referred to as the “fitness” or “payoff” and the appearance frequency may be referred to as the “probability”. Behaviors that appear in the data set 13 are behaviors that are indicated by at least one record out of the plurality of records included in the data set 13. When calculating evaluation values, the processing unit 12 does not have to calculate the evaluation values of the behaviors that do not appear in the data set 13.

In the example of FIG. 1, behaviors ST1, ST2, and ST3 appear in the data set 13. The distribution 14 indicates that the appearance frequency of the behavior ST1 is 40%, the appearance frequency of the behavior ST2 is 30%, and the appearance frequency of the behavior ST3 is 30%. The processing unit 12 calculates an evaluation value 15-1 (or “evaluation value P1”) for the behavior ST1, calculates an evaluation value 15-2 (or “evaluation value P2”) for the behavior ST2, and calculates an evaluation value 15-3 (or “evaluation value P3”) for the behavior ST3.

As one example, the processing unit 12 selects one behavior appearing in the data set 13 as the behavior of a certain player (hereinafter “present player”), and randomly selects the behaviors of other players according to the distribution 14. The behaviors of the other players may be behaviors indicated by records selected at random from the data set 13. The processing unit 12 calculates an evaluation value of the behavior of the present player through simulation, based on the selected behavior of the present player and the behaviors of the other players. An evaluation function that calculates the evaluation values may be referred to as a “fitness function” or a “payoff function”.

The processing unit 12 updates the data set 13 so as to increase the appearance frequency of behaviors whose evaluation values are larger than a threshold. When doing so, the processing unit 12 updates at least some records out of the plurality of records included in the data set 13, and changes the behaviors indicated by these records. The processing unit 12 may also update the data set 13 so that the appearance frequency of behaviors whose evaluation values are smaller than the threshold decreases. As one example, the processing unit 12 changes a behavior indicated by a certain record from a behavior with a low evaluation value to a behavior with a high evaluation value. The threshold may be a weighted average of evaluation values obtained by weighting the evaluation values of two or more behaviors appearing in the data set 13 according to the appearance frequencies.

As a result of changing the distribution of appearance frequencies according to the evaluation values, some behaviors may be culled from the data set 13 and disappear. As one example, the processing unit 12 determines the updated appearance frequency of each behavior based on the evaluation values. Since the size of the data set 13, that is, the number of records included in the data set 13 is finite, behaviors whose appearance frequency falls below a lower limit may disappear from the data set 13. As a result, the number of behaviors appearing in the data set 13 may fall. However, the processing unit 12 may also add behaviors, which have not appeared before in the data set 13, to the data set 13 and thereby prevent the number of behaviors appearing in the data set 13 from excessively falling.

As one example, the processing unit 12 performs a crossover where parts of two vectors indicated by two records are exchanged and adds records indicating new behaviors created by the crossover to the data set 13. As another example, the processing unit 12 performs a mutation where a part of one vector indicated by one record is changed at random, and adds a record indicating a new behavior created by the mutation to the data set 13. As a further example, the processing unit 12 randomly selects a behavior that does not appear in the data set 13 and adds a record indicating the selected behavior to the data set 13.

The processing unit 12 calculates an evaluation value for each of two or more behaviors that appears in the updated data set 13, out of the plurality of potential behaviors of a player, based on a distribution 16 of appearance frequencies of the behaviors in the updated data set 13. When doing so, the processing unit 12 does not have to calculate the evaluation values of behaviors that do not appear in the updated data set 13. Since the distribution 16 differs from the distribution 14, as a general rule the evaluation value of each behavior will change before and after updating.

In the example in FIG. 1, the behaviors ST1 and ST2 appear in the updated data set 13. The distribution 16 indicates that the appearance frequency of the behavior ST1 is 60% and the appearance frequency of the behavior ST2 is 40%. The behavior ST3 has been culled from the data set 13. The processing unit 12 calculates an evaluation value 17-1 (indicated as “evaluation value P11”) for the behavior ST1 and calculates an evaluation value 17-2 (indicated as “evaluation value P12”) for the behavior ST2. Since the behavior ST3 does not appear in the data set 13, the processing unit 12 does not need to calculate an evaluation value for the behavior ST3.

The processing unit 12 may further update the data set 13 according to the latest evaluation values. The processing unit 12 may repeat the calculation of the evaluation values and the updating of the data set 13 described above until a stopping condition is satisfied. The stopping condition may be the number of iterations reaching an upper limit, or may be convergence of the distribution of appearance frequencies. The distribution of appearance frequencies at the stopping point may be regarded as the equilibrium solution. The appearance frequencies of behaviors that do not appear in the data set 13 may be regarded as zero.

As described above, the information processing apparatus 10 according to the first embodiment calculates evaluation values for two or more behaviors that appear in the data set 13 based on a distribution of appearance frequencies of the two or more behaviors. The information processing apparatus 10 updates the data set 13 so that the appearance frequencies of behaviors whose evaluation values exceed a threshold increases. The information processing apparatus 10 calculates evaluation values for two or more behaviors that appear in the updated data set 13 based on the distribution of appearance frequencies after updating.

By doing so, behaviors that appear in the data set 13 are culled based on the evaluation values, which reduces the number of behaviors to be evaluated. Accordingly, compared to a pure form of discrete-time replicator dynamics, where the evaluation values of all behaviors are recalculated every time the probability distribution is updated, the load of calculating the evaluation values is reduced. As a result, the execution time taken by the search for an equilibrium solution is reduced. The distribution of appearance frequencies of behaviors in the data set 13 reflects the evaluation values, and approximates a probability distribution of every potential behavior of a player. This means that an approximate solution with sufficiently high accuracy as an equilibrium solution is calculated.

Note that the information processing apparatus 10 may add new behaviors to the data set 13 when updating the distribution of appearance frequencies of the data set 13. By doing so, a situation where there are too few behaviors to evaluate is avoided, and the accuracy of the equilibrium solution is improved. When determining the post-updating appearance frequency of each behavior, the information processing apparatus 10 may use a weighted average of an appearance frequency calculated based on the present evaluation value and the previous appearance frequency as the post-updating evaluation value. The previous appearance frequency may be the appearance frequency before the new behaviors were added. The appearance frequencies to be calculated based on the present evaluation values may be calculated by using the evaluation values to correct the appearance frequencies after the new behaviors were added. By doing so, sudden changes in the appearance frequencies are avoided, and the accuracy of the equilibrium solution is improved.

When recalculating the evaluation value of a certain behavior, the information processing apparatus 10 may use, as the evaluation value after updating, a weighted average of the evaluation value calculated based on the present distribution of appearance frequencies and the evaluation value before updating. By doing so, evaluation results based on a behavior selected in the past by another player and/or a random number selected in the past are appropriately reflected in the latest evaluation value, which makes the evaluation values more robust. As a result, the accuracy of the evaluation values is improved with a small number of simulations.

### Second Embodiment

A second embodiment will now be described.

In a situation where each of a plurality of players stochastically selects one pure strategy with the aim of maximizing a payoff, the probability distribution of the mixed strategy taken by the group of players may converge to a certain equilibrium solution. An information processing apparatus 100 according to the second embodiment searches for this equilibrium solution through simulation. This search for an equilibrium solution performed by the information processing apparatus 100 may be applied to analysis and institutional design of a large-scale social system, such as a supply chain.

The information processing apparatus 100 executes an improved genetic algorithm, which as described later is a genetic algorithm that has been improved based on discrete-time replicator dynamics. The information processing apparatus 100 may be a client apparatus or a server apparatus. The information processing apparatus 100 may be referred to as a “computer”, an “equilibrium solution searching apparatus”, or a “simulation apparatus”. The information processing apparatus 100 corresponds to the information processing apparatus 10 according to the first embodiment.

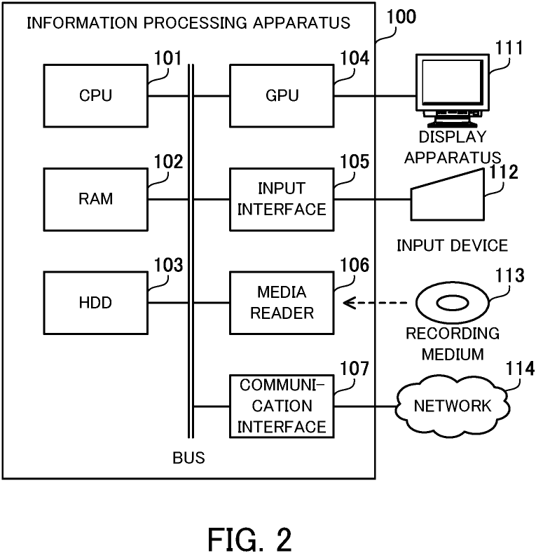

FIG. 2 depicts example hardware of the information processing apparatus according to the second embodiment.

The information processing apparatus 100 includes a CPU 101, a RAM 102, an HDD 103, a GPU 104, an input interface 105, a media reader 106, and a communication interface 107 that are connected to a bus. The CPU 101 corresponds to the processing unit 12 in the first embodiment. The RAM 102 or the HDD 103 corresponds to the storage unit 11 in the first embodiment.

The CPU 101 is a processor that executes instructions of a program. The CPU 101 loads at least part of a program and data stored in the HDD 103 into the RAM 102 and executes the program. The information processing apparatus 100 may include a plurality of processors. A group of processors may be referred to as a “multiprocessor” or simply as a “processor”.

The RAM 102 is a volatile semiconductor memory that temporarily stores a program to be executed by the CPU 101 and data used for computation by the CPU 101. The information processing apparatus 100 may include another type of volatile memory aside from RAM.

The HDD 103 is non-volatile storage that stores software programs, such as an operating system (OS), middleware, and application software, as well as data. The information processing apparatus 100 may include other types of non-volatile storage, such as flash memory or a solid state drive (SSD).

The GPU 104 performs image processing in cooperation with the CPU 101 and outputs images to a display apparatus 111 connected to the information processing apparatus 100. As examples, the display apparatus 111 is a cathode ray tube (CRT) display, a liquid crystal display, an organic electro luminescence (EL) display, or a projector. Note that the information processing apparatus 100 may be connected to another type of output device, such as a printer.

The GPU 104 may also be used as a general-purpose computing on graphics processing unit (GPGPU). The GPU 104 may execute a program according to instructions from the CPU 101. This program may be a program that implements a genetic algorithm, which will be described later. The information processing apparatus 100 may also include volatile semiconductor memory aside from the RAM 102 as GPU memory used by the GPU 104.

The input interface 105 receives an input signal from an input device 112 connected to the information processing apparatus 100. As examples, the input device 112 is a mouse, a touch panel, or a keyboard. A plurality of input devices may be connected to the information processing apparatus 100.

The media reader 106 is a reader apparatus that reads programs and data recorded on a recording medium 113. As examples, the recording medium 113 is a magnetic disk, an optical disc, or a semiconductor memory. Magnetic disks include flexible disks (FDs) and HDDs. Optical discs include compact discs (CDs) and digital versatile discs (DVDs). The media reader 106 copies the program and data read from the recording medium 113 into another recording medium, such as the RAM 102 or the HDD 103. The read program may be executed by the CPU 101.

The recording medium 113 may be a portable recording medium. The recording medium 113 may be used to distribute programs and data. The recording medium 113 and the HDD 103 may also be referred to as “computer-readable recording media”.

The communication interface 107 communicates with other information processing apparatuses via a network 114. The communication interface 107 may be a wired communication interface connected to a wired communication apparatus, such as a switch or router, or may be a wireless communication interface connected to a wireless communication apparatus, such as a base station or an access point.

Next, discrete-time replicator dynamics (hereinafter sometimes referred to simply as “replicator dynamics”) will be described. Replicator dynamics iteratively calculates the payoffs of individual strategies and updates the probability distributions of mixed strategies.

Replicator dynamics calculates the payoffs of each of a plurality of strategies under the present probability distribution. Replicator dynamics increases the probability of a strategy whose payoff exceeds the average payoff of the plurality of strategies as a whole according to the ratio of the individual payoff to the average payoff. Replicator dynamics also decreases the probability of a strategy whose payoff is below the average payoff according to the ratio of the individual payoff to the average payoff. By doing so, strategies with relatively large payoffs become more likely to be selected, and strategies with relatively small payoffs become less likely to be selected.

When the probability distribution changes, the respective payoffs of a plurality of strategies will also change. For this reason, replicator dynamics recalculates the payoff of each strategy every time the probability distribution is updated. However, recalculating the payoff of each strategy in every iteration creates a large load for calculating payoffs.

For this reason, the information processing apparatus 100 efficiently calculates an approximate solution for replicator dynamics using an improved genetic algorithm. The information processing apparatus 100 approximates the probability distribution of a mixed strategy using a population used in a genetic algorithm. With a genetic algorithm, strategies included in the population are gradually culled, which gradually reduces the strategies for which a payoff is calculated. Also, since new strategies are stochastically added to the population through crossover and mutation, this ensures that there are opportunities to evaluate new strategies aside from the strategies that have been narrowed down.

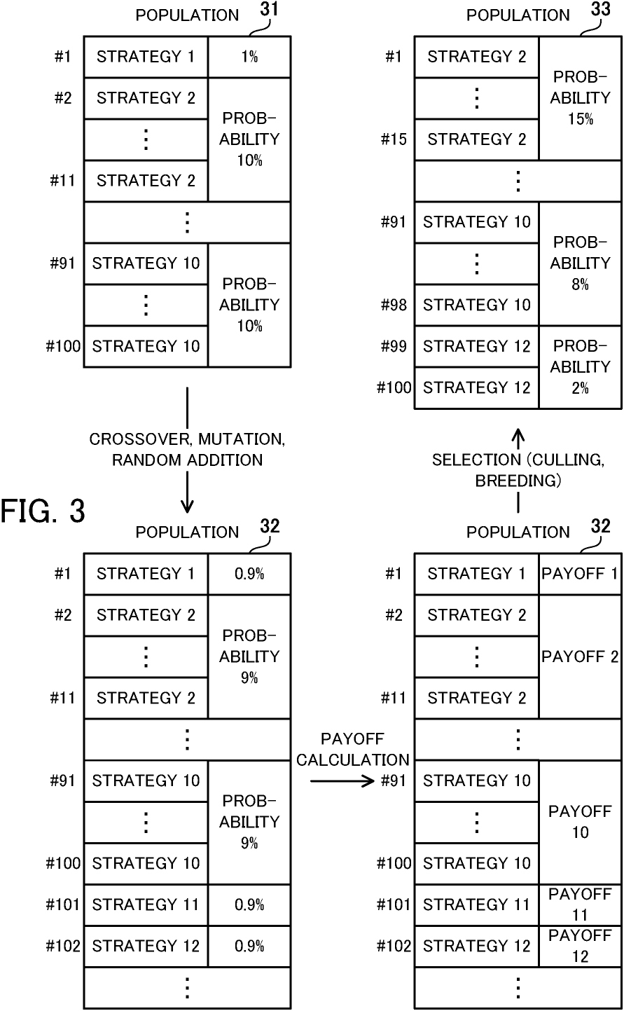

FIG. 3 depicts an example updating of a population by an improved genetic algorithm.

The information processing apparatus 100 generates a population 31. The population 31 is a data set including a fixed number of individuals. In the example in FIG. 3, the population 31 includes one hundred individuals. Each individual corresponds to a gene for a genetic algorithm. Each individual indicates any one out of a plurality of strategies that are defined in advance. As one example, a strategy is expressed by a vector including numerical values on a plurality of dimensions. The proportion of individuals indicating a certain strategy out of the individuals included in the entire population 31 corresponds to the probability of that strategy being selected. A list of the probabilities of two or more strategies that appear in the population 31 corresponds to a probability distribution of mixed strategies.

In the example in FIG. 3, the population 31 includes one individual indicating a first strategy, ten individuals indicating a second strategy, and ten individuals indicating a tenth strategy. This means that the probability of the first strategy is 1%, the probability of the second strategy is 10%, and the probability of the tenth strategy is 10%.

The information processing apparatus 100 generates a population 32 by adding individuals to the population 31 through crossover, mutation, and random addition. The population 32 is larger than the population 31 in size. A crossover selects two individuals at random from the population 31 and exchanges numerical values of some dimensions between the two vectors indicated by the selected two individuals. When the strategy generated by the crossover is a new strategy that is not included in the population 31, the information processing apparatus 100 adds an individual indicating that new strategy to the population 31. When the strategy generated by the crossover is already included in the population 31, the information processing apparatus 100 does not need to add new individuals.

Mutation selects one individual at random from the population 31, and randomly rewrites the numerical values of some dimensions in the vector indicated by the selected individual. When the strategy generated by the mutation is a new strategy that is not included in the population 31, the information processing apparatus 100 adds an individual indicating that new strategy to the population 31. When the strategy generated by the mutation is already included in the population 31, the information processing apparatus 100 does not need to add new individuals.

Random addition randomly generates a new strategy that is not included in the population 31. The information processing apparatus 100 adds an individual indicating the new strategy to the population 31. Since repeatedly updating the probability distribution when the number of strategies is exceedingly small may make the probability distribution unstable, random addition is performed to keep the number of strategies at a certain level or above.

In the example in FIG. 3, in addition to the individuals of the population 31, the population 32 includes new individuals such as an individual indicating an eleventh strategy and an individual indicating a twelfth strategy. In the population 32, the probability of the first strategy is 0.9%, the probability of the second strategy is 9%, the probability of the tenth strategy is 9%, the probability of the eleventh strategy is 0.9%, and the probability of the twelfth strategy is 0.9%.

The information processing apparatus 100 calculates the payoff of each strategy included in the population 32 using a payoff function defined in advance. When doing so, the information processing apparatus 100 does not need to calculate a payoff for strategies that are not included in the population 32. The payoff calculated by the payoff function depends on the probability distribution indicated by the population 31. A specific example of the payoff function will be described later in this specification.

As one example, the information processing apparatus 100 selects one strategy of a present player in focus out of the population 32. In addition, the information processing apparatus 100 selects the strategies of other players according to the probability distribution by extracting individuals at random from the population 31. The information processing apparatus 100 performs a simulation based on the selected strategy of the present player and the strategies of the other players to calculate the payoff of the present player. At this time, the simulation may use random numbers to express fluctuations in the external environment which is unaffected by any decision-making by the players. The simulation may also be performed a plurality of times while changing the strategies of the other players and/or the random numbers.

Since individuals are extracted from the population 31, a new strategy immediately following addition by crossover, mutation, or random addition will not be selected as the strategy of another player. This is because the new strategy will not have been evaluated by the payoff function and is yet to be assigned a highly reliable probability. However, by extracting individuals from the population 32, the information processing apparatus 100 may allow new strategies to be selected as the strategies of other players.

Based on the calculated payoffs, the information processing apparatus 100 determines the respective next-generation probabilities of each strategy included in the population 32 according to Expression (1). In Expression (1), k is a natural number and pᵢ(k) is the k^{th} generation payoff of strategy i. xᵢ(k) is the probability of strategy i in the k^{th} generation before new strategies are added, and corresponds to the probability for the population 31. x′ᵢ(k) is the probability in the k^{th} generation of strategy i after the new strategies have been added, and corresponds to the probability for the population 32. Σpⱼ(k)x′ⱼ(k) is the average payoff obtained by weighting the payoffs of two or more strategies that appear in the k^{th} generation population by their respective probabilities. 1r is a learning rate that is determined in advance and takes a numerical value that is greater than 0 and less than 1.

$${x}_{i} \left(k + 1\right) = \left(1 - l r\right) {x}_{i} \left(k\right) + l r {{x}^{′}}_{i} \left(k\right) \frac{{p}_{i} \left(k\right)}{{\sum }_{j = 1}^{n} {p}_{j} \left(k\right) {{x}^{′}}_{j} \left(k\right)} \qquad \text{(1)}$$

As indicated in Expression (1), the probability of a strategy with a payoff that exceeds the average payoff increases according to the ratio of the individual payoff to the average payoff. On the other hand, the probability of a strategy with a payoff below the average payoff decreases according to the ratio of the individual payoff to the average payoff. Also, the weighted average of a probability that has been adjusted based on the payoff for the k^{th} generation and the probability of the k^{th} generation is used as the probability of the k+1^{th} generation. By using the learning rate lr, sudden fluctuations in probability are suppressed, which stabilizes the probability distribution. The greater the learning rate lr, the stronger the recent payoff is reflected in the probability.

Note that xᵢ(k)=0 for new strategies added by the most recent crossover, mutation, or random addition. Also, when k=1, since crossover, mutation, and random addition are yet to be performed, xᵢ(k)=x′ᵢ(k). When the payoff pⱼ(k) of a certain strategy j is negative, the information processing apparatus 100 calculates Σpⱼ(k)x′ⱼ(k) by assuming that pⱼ(k)x′ⱼ(k)=0.

The information processing apparatus 100 generates a population 33 by performing a selection operation on the population 32 according to the determined probabilities. A selection operation includes culling, where a certain individual is deleted to reduce the number of individuals for the strategy indicated by that individual, and breeding, where a certain individual is duplicated to increase the number of individuals for the strategy indicated by that individual. The population 33 has the same size as the population 31. In the example in FIG. 3, the population 33 includes one hundred individuals. The number of individuals for each strategy included in the population 33 is calculated based on the probabilities and corresponds to the size of the population 33 multiplied by the probabilities. However, the number of individuals for each strategy does not have to strictly match a number obtained by multiplying the size of the population 33 by the probability.

Since the population 33 has a finite number of individuals, a strategy with a sufficiently low probability will disappear without remaining in the population 33. When the population 33 includes one hundred individuals, strategies whose probability is under 1% may disappear. In the example in FIG. 3, the probability of the second strategy is 15%, the probability of the tenth strategy is 8%, and the probability of the twelfth strategy is 2%. Accordingly, the population 33 includes fifteen individuals indicating the second strategy, eight individuals indicating the tenth strategy, and two individuals indicating the twelfth strategy. The first strategy and the eleventh strategy included in the population 32 are culled because their determined probabilities are sufficiently small, and are therefore not included in the population 33.

Here, when a certain strategy is included in the (k-1)^{th} generation population and is also included in the k^{th} generation population, the information processing apparatus 100 calculates the k^{th} generation payoff according to Expression (2). In Expression (2), p(k) is the payoff of the k^{th} generation, p(k-1) is the payoff of the (k-1)^{th} generation, and p^{tmp} (k) is the payoff calculated by simulation for the k^{th} generation. w is a weighting determined in advance, and is a numerical value that is greater than 0 but less than 1.

$$p \left(k\right) = \left(1 - w\right) p \left(k - 1\right) + w {p}^{t m p} \left(k\right) \qquad \text{(2)}$$

Accordingly, the payoff of the k^{th} generation is the weighted average of the payoff of the (k-1)^{th} generation and the simulation result for the k^{th} generation. By doing so, sudden fluctuations in the payoff are suppressed. In addition, the results of past simulations performed for different strategies of the other players and different random numbers are reflected to some extent in the payoff of the latest generation. This means that an appropriate payoff is likely to be calculated even when the number of simulation trials for calculating one payoff is small.

The information processing apparatus 100 generates the first generation population as follows. First, the information processing apparatus 100 generates a temporary population including all potential strategies for the player. When doing so, the probabilities of the plurality of strategies are assumed to be equal. As one example, the information processing apparatus 100 generates a temporary population including one individual per strategy. However, when the number of strategies is exceedingly large, the information processing apparatus 100 may extract some strategies from the entire group of strategies. As one example, the information processing apparatus 100 uses an experimental design method, such as Latin hypercube sampling, to sample some strategies with little bias from the entire group of strategies.

The information processing apparatus 100 calculates the payoff for each strategy included in the temporary population described above by simulation. When doing so, the strategy of the present player and the strategies of other players are selected from the same population with a uniform probability distribution. The information processing apparatus 100 then determines the first generation probability of each strategy based on the calculated payoff and Expression (1) described earlier, and generates a first generation population according to the determined first generation probabilities. Since a wide range of strategies (preferably the entire group of strategies) are considered in the first generation, the risk that a preferred strategy is not included in the first generation population is reduced, which improves the reliability of the final equilibrium solution.

Next, a supply chain will be described as one example of a simulation.

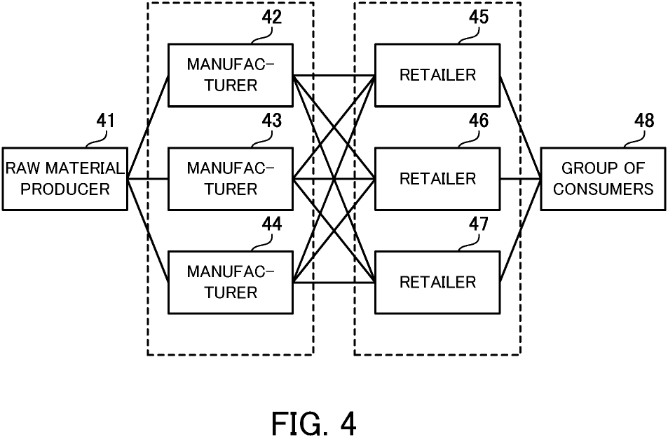

FIG. 4 depicts one example of players in a simulation.

The supply chain includes a raw material producer 41, manufacturers 42, 43, and 44, retailers 45, 46, and 47 and a group of consumers 48 as actors. The raw material producer 41 sells raw materials to the manufacturers 42, 43, and 44. The manufacturers 42, 43, and 44 purchase raw materials from the raw material producer 41, manufacture products, and sell the products to the retailers 45, 46, and 47. The retailers 45, 46, and 47 purchase products from the manufacturers 42, 43, and 44 and sell the products to the group of consumers 48. The group of consumers 48 purchase products from the retailers 45, 46, and 47.

The information processing apparatus 100 calculates transaction volumes and transaction prices of products determined through transactions between the manufacturers 42, 43, and 44 and the retailers 45, 46, and 47. The transactions between the manufacturers 42, 43, and 44 and the retailers 45, 46, and 47 are modeled by a double auction in which desired transaction volumes and transaction prices are specified on both the manufacturer side and the retailer side.

The manufacturers 42, 43, and 44 and the retailers 45, 46, and 47 are players. The manufacturers 42, 43, and 44 form a pool of players that stochastically select strategies based on the same mixed strategy. Likewise, the retailers 45, 46, and 47 form a pool of players who stochastically select strategies based on the same mixed strategy. The manufacturer-side population and the retailer-side population are formed separately and are respectively optimized by the improved genetic algorithm described earlier. However, since the mixed strategy on the manufacturer side and the mixed strategy on the retailer side influence each other, when calculating the payoffs, the information processing apparatus 100 performs simulations by selecting strategies for each of the manufacturers 42, 43, and 44 and the retailers 45, 46, and 47.

When calculating the payoff of one strategy on the manufacturer side, the information processing apparatus 100 regards the manufacturer 42 as the present player, and the manufacturers 43 and 44 and the retailers 45, 46, and 47 as other players. The information processing apparatus 100 selects the strategies of the manufacturers 43 and 44 at random from the manufacturer-side population, and selects the strategies of the retailers 45, 46, and 47 at random from the retailer-side population. When calculating the payoff of one strategy on the retailer side, the information processing apparatus 100 regards the retailer 45 as the present player, and regards the manufacturers 42, 43, and 44 and the retailers 46 and 47 as the other players. The information processing apparatus 100 selects strategies for the manufacturers 42, 43, and 44 at random from the manufacturer-side population and selects strategies for the retailers 46 and 47 at random from the retailer-side population.

After the respective payoffs of the manufacturer-side strategy and the retailer-side strategy have been calculated, the information processing apparatus 100 determines the probability of each of the manufacturer-side strategies and updates the manufacturer-side population. Also, independently of the manufacturer side, the information processing apparatus 100 determines the probability of each of the retailer-side strategies and updates the retailer-side population. However, the improved genetic algorithm according to the second embodiment is not limited to a case where there are two or more groups of players, and may be applied to a case where there is only one group of players.

The raw material producer 41 and the group of consumers 48 are non-players. However, the raw material prices of the raw materials sold by the raw material producer 41 fluctuate randomly, which from the viewpoint of the manufacturers 42, 43, and 44 corresponds to an external environment where the manufacturers do not have control. In addition, the demanded volume of the products purchased by the group of consumers 48 fluctuates randomly, which from the viewpoint of the retailers 45, 46, and 47 corresponds to an external environment where the retailers do not have control. The product prices of the products purchased by the group of consumers 48 from retailers 45, 46, and 47 are fixed. The information processing apparatus 100 calculates the payoff of the manufacturer 42 and the payoff of the retailer 45 when thirty transactions (as one example, one transaction per day for thirty days) have been continuously performed under the same strategy.

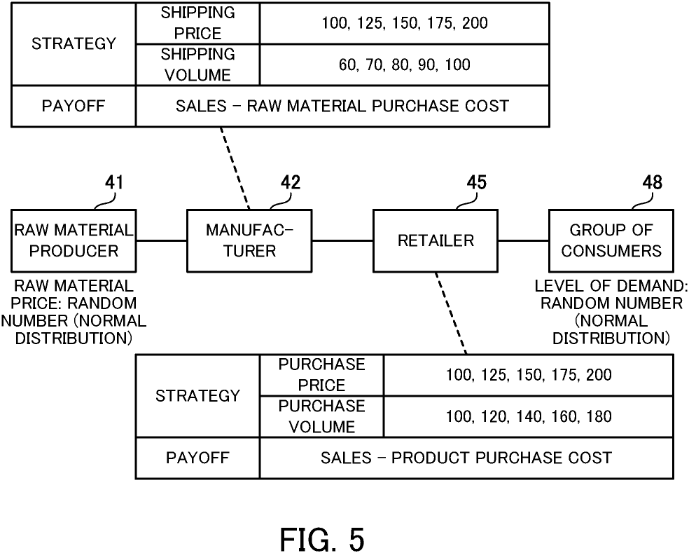

FIG. 5 depicts example strategies and a definition of payoff in a simulation.

The raw material prices of the raw material producer 41 fluctuate daily according to a normal distribution determined in advance. Random numbers are used to determine the raw material prices. The (level of) demand of the group of consumers 48 also fluctuates daily according to a normal distribution determined in advance. Random numbers are used to determine this demand.

The strategies of the manufacturers 42, 43, and 44 are two-dimensional vectors each including a shipping price and a shipping volume. The shipping price is the unit price of products, and is a value selected from 100 yen, 125 yen, 150 yen, 175 yen, and 200 yen. 100 yen may be encoded as “0”, 125 yen as “1”, 150 yen as “2”, 175 yen as “3”, and 200 yen as “4”. The shipping volume is the daily shipping volume and is selected from 60, 70, 80, 90, and 100 pieces. 60 may be encoded as “0”, 70 as “1”, 80 as “2”, 90 as “3”, and 100 as “4”. The payoffs of the manufacturers 42, 43, and 44 are the gross profits obtained by subtracting the 30-day purchase cost of raw materials from 30-day sales.

The strategies of the retailers 45, 46, and 47 are two-dimensional vectors each including a purchase price and a purchase volume. The purchase price is the unit price of products, and is selected from 100 yen, 125 yen, 150 yen, 175 yen, and 200 yen. 100 yen may be encoded as “0”, 125 yen as “1”, 150 yen as “2”, 175 yen as “3”, and 200 yen as “4”. The purchase volume is the daily purchase volume and is selected from 100, 120, 140, 160, and 180 pieces. 100 may be encoded as “0”, 120 as “1”, 140 as “2”, 160 as “3”, and 180 as “4”.

The payoffs of the retailers 45, 46, and 47 are the gross profit obtained by subtracting 30-day product purchases from 30-day sales. Note that for the retailers 45, 46, and 47, a product volume obtained by adding the purchase volume to the present inventory is a potential sales volume. When there is demand that exceeds the potential sales volume, the difference is an opportunity loss. When demand is below the potential sales volume, the difference becomes the inventory for the next day.

When the manufacturers 42, 43, and 44 and the retailers 45, 46, and 47 each select a strategy and present a desired transaction price and transaction volume, an appropriate transaction price and transaction volume are determined by a double auction. Although transaction volume will differ between businesses, the transaction price is determined as a common market price for the manufacturers 42, 43, and 44 and the retailers 45, 46, and 47. This market price may be determined according to a method such as “Itayose” in Japanese securities trading.

As one example, the information processing apparatus 100 sorts the manufacturers 42, 43, and 44 in ascending order of desired shipping price, and sorts the retailers 45, 46, and 47 in descending order of desired purchase price. The information processing apparatus 100 preferentially assigns shipping rights to the highest ranked manufacturer, and preferentially assigns purchasing rights to the highest ranked retailer. The information processing apparatus 100 compares the desired shipping price of the manufacturer with the shipping rights and the desired purchase price of the retailer with the purchasing rights and, when the desired shipping price is lower than the desired purchase price, establishes a transaction between the manufacturer and the retailer. The transaction volume is the smaller of an unsatisfied portion of the desired shipping volume and an unsatisfied portion of the desired purchase volume.

When the desired shipping volume of the manufacturer with the shipping rights is completely satisfied by an established transaction, the information processing apparatus 100 assigns the shipping rights to the manufacturer with the next highest ranking. Likewise, when the desired purchase volume of the retailer with the purchasing rights is completely satisfied by an established transaction, the information processing apparatus 100 assigns the purchasing rights to the retailer with the next highest ranking. When the desired shipping volumes of all of the manufacturers 42, 43, and 44 are satisfied, or when the desired purchase volumes of all of the retailers 45, 46, and 47 are satisfied, the information processing apparatus 100 ends the auction. The information processing apparatus 100 also ends the auction when the desired prices are incompatible and no more transactions may be established.

The respective transaction volumes of the manufacturers 42, 43, and 44 and the retailers 45, 46, and 47 are the transaction volumes of the transactions established for each of the businesses via the procedure described above. On the other hand, the transaction prices of manufacturers 42, 43, and 44 and the retailers 45, 46, and 47 are the single market price calculated from how the transactions were established. When the total of the desired shipping volumes of the manufacturers 42, 43, and 44 is less than the total of the desired purchase volumes of the retailers 45, 46, and 47, the transaction price is the desired purchase price of the final retailer with the purchasing rights. When the total of the desired shipping volumes is greater than the total of the desired purchase volumes, the transaction price is the desired shipping price of the final manufacturer with the shipping rights.

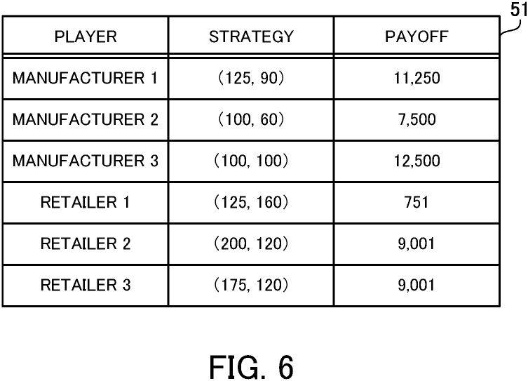

FIG. 6 depicts example results of one iteration of a simulation.

Table 51 indicates the respective strategies selected by and payoffs achieved by the manufacturers 42, 43, and 44 and the retailers 45, 46, and 47 in one iteration of a simulation.

The manufacturer 42 selects a strategy with 125 yen as the shipping price and 90 units as the shipping volume, and acquires a payoff of 11,250 yen. The manufacturer 43 selects a strategy with 100 yen as the shipping price and 60 units as the shipping volume, and acquires a payoff of 7,500 yen. The manufacturer 44 selects a strategy with 100 yen as the shipping price and 100 units as the shipping volume, and acquires a payoff of 12,500 yen.

The retailer 45 selects a strategy with 125 yen as the purchase price and 160 units as the purchase volume, and obtains a payoff of 751 yen. The retailer 46 selects a strategy with 200 yen as the purchase price and 120 units as the purchase volume, and obtains a payoff of 9,001 yen. The retailer 47 selects a strategy with 175 yen as the purchase price and 120 units as the purchase volume, and obtains a payoff of 9,001 yen.

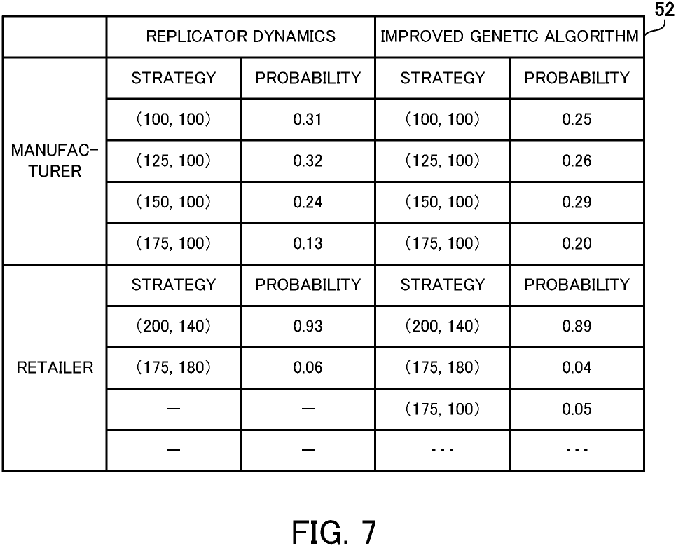

FIG. 7 depicts an example of a probability distribution of a mixed strategy after convergence.

Table 52 indicates mixed strategies for the supply chain depicted in FIG. 4 that have been respectively optimized by normal replicator dynamics and an improved genetic algorithm. In this example, the following numerical values are used as the parameter values of the improved genetic algorithm. The manufacturer-side population and the retailer-side population each have 100 individuals. The crossover probability is 30%, the mutation probability is 30%, and the number of randomly added individuals is 5. The learning rate lr is 0.7 and the weighting w is 0.5.

Replicator dynamics calculates the following mixed strategy for manufacturers as the equilibrium solution. This mixed strategy includes a strategy with a shipping price of 100 yen and a shipping volume of 100 at 31%, and a strategy with a shipping price of 125 yen and a shipping volume of 100 at 32%. This mixed strategy also includes a strategy with a shipping price of 150 yen and a shipping volume of 100 at 24%, and a strategy with a shipping price of 175 yen and a shipping volume of 100 at 13%.

On the other hand, the improved genetic algorithm according to the second embodiment calculates the following mixed strategy for manufacturers as the equilibrium solution. This mixed strategy includes a strategy with a shipping price of 100 yen and a shipping volume of 100 at 25%, and a strategy with a shipping price of 125 yen and a shipping volume of 100 at 26%. This mixed strategy also includes a strategy with a shipping price of 150 yen and a shipping volume of 100 at 29%, and a strategy with a shipping price of 175 yen and a shipping volume of 100 at 20%.

Replicator dynamics calculates the following mixed strategy for retailers as the equilibrium solution. This mixed strategy includes a strategy with a purchase price of 200 yen and a purchase volume of 140 at 93%, and a strategy with a purchase price of 175 yen and a purchase volume of 180 at 6%. On the other hand, the improved genetic algorithm according to the second embodiment calculates the following mixed strategy for retailers as the equilibrium solution. This mixed strategy includes a strategy with a purchase price of 200 yen and a purchase volume of 140 at 89%, a strategy with a purchase price of 175 yen and a purchase volume of 180 at 4%, and a strategy with a purchase price of 175 yen and a purchase volume of 100 at 5%.

In this way, the improved genetic algorithm of the second embodiment approximates the equilibrium solution of the mixed strategy of manufacturers calculated by replicator dynamics with high accuracy. In the same way, the improved genetic algorithm approximates the equilibrium solution of the mixed strategy of retailers calculated by replicator dynamics with high accuracy.

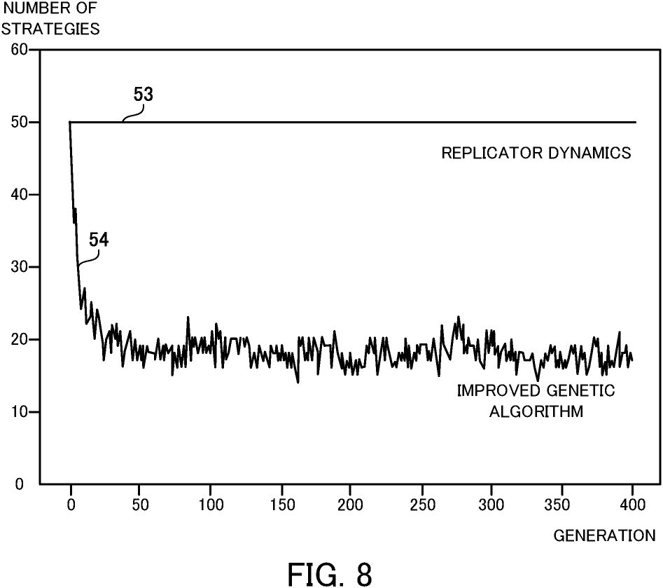

FIG. 8 is a graph depicting example changes to the number of strategies whose payoffs are calculated.

A straight line 53 and a curve 54 depict the relationship between the generation number and the number of strategies whose payoffs are to be calculated. The straight line 53 indicates changes in the number of strategies for replicator dynamics, and the curve 54 indicates changes in the number of strategies for the improved genetic algorithm according to the second embodiment.

In the supply chain in FIG. 4, there are twenty-five possible manufacturer-side strategies and twenty-five possible retailer-side strategies, making a total of fifty strategies. As indicated by the straight line 53, regular replicator dynamics will compute payoffs of these fifty strategies in every generation. On the other hand, as indicated by the curve 54, the improved genetic algorithm narrows down the strategies to about twenty strategies through culling in the first several tens of generations, and thereafter calculates the payoffs of around twenty strategies in each generation.

The area under the straight line 53, that is, the integral of the number of strategies indicated by the straight line 53, corresponds to the amount of calculation and the calculation time for calculating payoffs using replicator dynamics. The area under the curve 54, that is, the integral of the number of strategies indicated by the curve 54, corresponds to the amount of calculation and the calculation time for calculating payoffs using the improved genetic algorithm. Compared to regular replicator dynamics, the improved genetic algorithm is executed with a small amount of computation and a short computation time.

Next, the functions and processing procedure of the information processing apparatus 100 will be described.

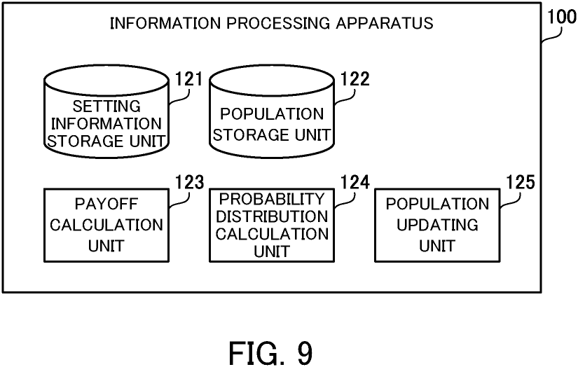

FIG. 9 is a block diagram depicting example functions of an information processing apparatus.

The information processing apparatus 100 includes a setting information storage unit 121, a population storage unit 122, a payoff calculation unit 123, a probability distribution calculation unit 124, and a population updating unit 125. The setting information storage unit 121 and the population storage unit 122 are implemented using the RAM 102 or the HDD 103, for example. As one example, the payoff calculation unit 123, the probability distribution calculation unit 124, and the population updating unit 125 are implemented using the CPU 101 and one or more programs.

The setting information storage unit 121 stores setting information for executing the improved genetic algorithm. The setting information includes parameter values such as the size of the population, the crossover probability, the mutation probability, the number of randomly added individuals, the learning rate lr, the weighting w, and an upper limit on the number of generations. The setting information also includes a definition of vectors indicating strategies and a payoff function. The population storage unit 122 stores one or more populations. In addition, the population storage unit 122 stores a payoff and a probability calculated for each strategy.

The payoff calculation unit 123 calculates payoffs for each strategy included in the population by performing a plurality of simulations. In each simulation, the payoff calculation unit 123 selects other players’ strategies according to the present probability distribution by extracting individuals at random from the population. The payoff calculation unit 123 also selects a random number to determine the external environment used in a simulation. The payoff calculation unit 123 uses the payoff function to calculate the payoff of the present player from the strategy of the present player, the strategies of the other players, and the external environment. The payoffs from a plurality of simulations are averaged. The probability distribution calculation unit 124 updates the probability of each strategy included in the population based on the payoffs calculated by the payoff calculation unit 123.

To generate the first generation population, the population updating unit 125 generates a temporary population that exhaustively includes every strategy or a temporary population including only some strategies selected in a manner that has little bias. The population updating unit 125 also generates a population of a fixed size so that individuals indicating a plurality of strategies are included with proportions indicated by the probability distribution calculated by the probability distribution calculation unit 124. Due to this selection operation, some strategies may be culled from the population. The population updating unit 125 adds individuals indicating new strategies by crossover, mutation, and random addition to the population following the selection operation.

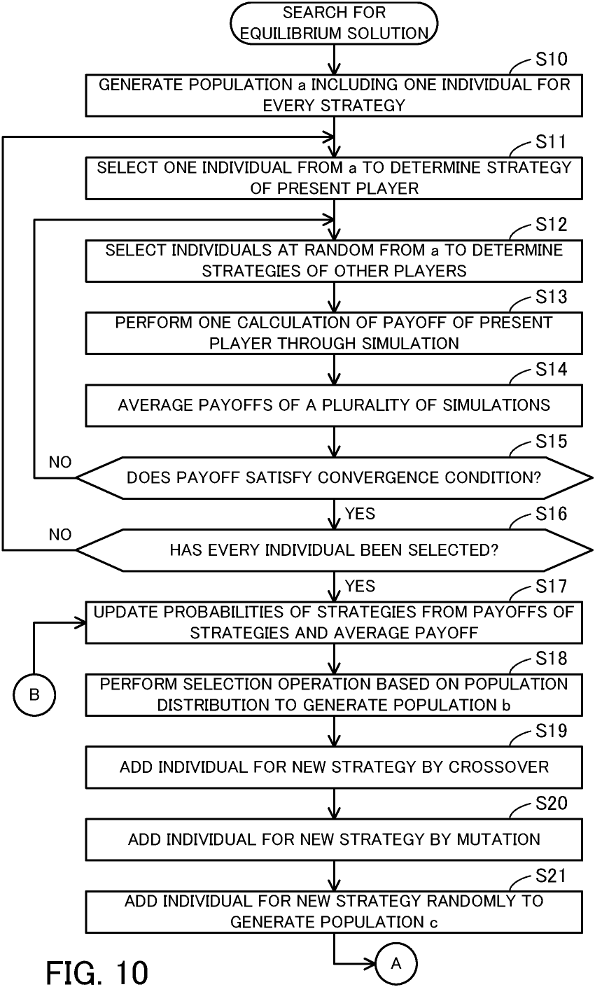

FIG. 10 is a flowchart depicting the processing procedure of a search for an equilibrium solution.

(S10) The population updating unit 125 generates a temporary population including one individual for every strategy. Hereinafter, this population will be referred to as the “population a”.

(S11) The payoff calculation unit 123 selects one individual from the population a, and determines the strategy indicated by the selected individual as the strategy of the present player.

(S12) The payoff calculation unit 123 selects one individual at random from the population a for each other player, and determines the strategies indicated by the selected individuals as the strategies of the other players. When it is assumed that the number of individuals in the population a is Nₐ, each strategy is selected with a probability of 1/Nₐ.

(S13) The payoff calculation unit 123 performs a simulation according to the strategy of the present player and the strategies of the other players that have been determined to perform one calculation of the payoff of the present player.

(S14) When steps S12 to S15 have been performed for a plurality of iterations, the payoff calculation unit 123 averages the payoffs calculated in step S13.

(S15) The payoff calculation unit 123 determines whether the payoff for the strategy of the present player selected in step S11 satisfies a convergence condition. The convergence condition is that the number of iterations of steps S12 to S15 exceeds a first threshold decided in advance and the rate of change in the average payoff of the present iteration with respect to the average payoff of the previous iteration is below a second threshold decided in advance. As one example, the second threshold is the reciprocal of the number of individuals in the population a. When the convergence condition is satisfied, the processing proceeds to step S16, and when the convergence condition is not satisfied, the processing returns to step S12. Note that when the convergence condition is satisfied, the average payoff of the present iteration is regarded as the payoff of the strategy selected in step S11.

(S16) The payoff calculation unit 123 determines whether every individual included in the population a has been selected. When every individual has been selected, the processing proceeds to step S17, and when there are unselected individuals in the population a, the processing returns to step S11.

(S17) The probability distribution calculation unit 124 calculates an average payoff obtained by weighting the payoffs of the plurality of strategies included in the latest population by their respective probabilities. The probability distribution calculation unit 124 updates the probability of each strategy included in the latest population based on the individual payoffs and the average payoff. For the first generation, the latest population is the population a of step S10. For the second and subsequent generations, the latest population is a population c, which will be described later. However, as the probabilities before updating, both the probabilities of a population b, described later, and the probabilities in the population c are used.

When it is assumed that the number of individuals in the population a is Nₐ, the probability before updating in the population a is 1/Nₐ. When it is assumed that the number of individuals in the population b is N_{b} and the number of individuals with a certain strategy in the population b is N_{bi}, the probability before updating for the population b is N_{bi}/N_{b}. When it is assumed that the number of individuals in the population c is N_{c} and the number of individuals with a certain strategy in the population c is N_{ci}, the probability before updating for the population c is N_{ci}/N_{c}. The probability distribution calculation unit 124 corrects the probabilities for the population c based on individual payoffs and the average payoff, and combines the probabilities for the population b with the corrected probabilities at the learning rate lr.

(S18) Based on the probability distribution updated in step S17, the population updating unit 125 performs a selection operation including culling and breeding of the latest population to generate the population b. The number of individuals for each strategy in the population b is adjusted to the probability of that strategy. However, since the number of individuals in the population b is finite, the proportions of the respective strategies in the population b do not have to strictly match the probabilities calculated in step S17. The probability of each strategy is approximated using the ratio of the number of individuals in the population b. When the ratio of individuals for a strategy whose probability has decreased approaches 0%, that strategy disappears from the population b.

(S19) The population updating unit 125 performs crossover on the population b with a certain probability. During a crossover, two individuals are selected at random from the population b and the numerical values of some dimensions are exchanged between the selected two individuals. When the strategy generated by the crossover is a new strategy that is not included in the population b, the population updating unit 125 adds individuals with the new strategy to population b. The number of individuals added may be one for each new strategy. Note that the new strategy may be a strategy that appeared in the population two or more generations ago.

(S20) The population updating unit 125 performs mutation on the population b with a certain probability. During a mutation, one individual is selected at random from the population b and the numerical values of some dimensions of the selected individual are rewritten. When the strategy resulting from the mutation is a new strategy that is not included in the population b, the population updating unit 125 adds individuals with the new strategy to the population b. The number of added individuals may be one for each new strategy.

(S21) The population updating unit 125 randomly generates a certain number of new strategies that are not included in the population b, and adds individuals with the new strategies to the population b. The number of added individuals may be one for each new strategy. The population c is generated by steps S19 to S21.

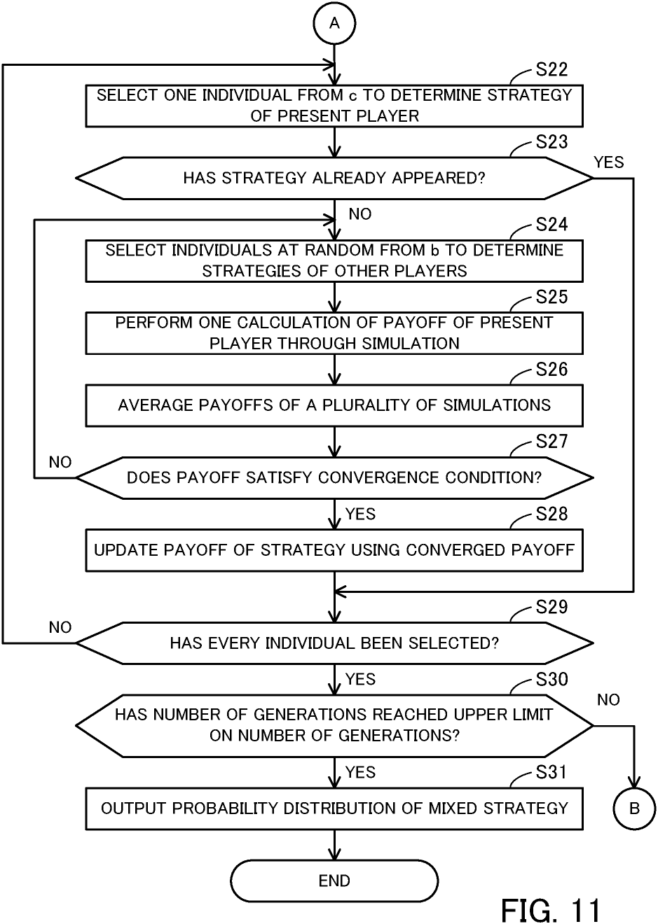

FIG. 11 is a flowchart further depicting the processing procedure of a search for an equilibrium solution.

(S22) The payoff calculation unit 123 selects one individual from the latest population c and determines the strategy indicated by the selected individual as the strategy of the present player.

(S23) The payoff calculation unit 123 determines whether the strategy of the present player selected in step S22 has already appeared during the iterations of steps S22 to S29, that is, whether a payoff for the strategy selected in step S22 has already been calculated. When the strategy has already appeared, the processing proceeds to step S29, and when the strategy has not appeared before, the processing proceeds to step S24.

(S24) The payoff calculation unit 123 selects one individual at random from the latest population b for each other player, and determines the strategies indicated by the selected individuals as the strategies of the other players. When it is assumed that the number of individuals in the population b is N_{b} and the number of individuals with a certain strategy is N_{bi}, that strategy will be selected with a probability of N_{bi}/N_{b}.

(S25) The payoff calculation unit 123 performs a simulation according to the strategy of the present player and the strategies of the other players that have been determined to perform one calculation of the payoff of the present player.

(S26) When steps S24 to S27 have been performed for a plurality of iterations, the payoff calculation unit 123 averages the payoffs calculated in step S25.

(S27) The payoff calculation unit 123 determines whether the payoff for the strategy of the present player selected in step S22 satisfies a convergence condition. The convergence condition is that the number of iterations of steps S24 to S27 exceeds a first threshold and the rate of change in the average payoff of the present iteration with respect to the average payoff of the previous iteration is below a second threshold. As one example, the second threshold is the reciprocal of the number of individuals in the population c. The first threshold may be the same as or different from step S15. When the convergence condition is satisfied, the processing proceeds to step S28, and when the convergence condition is not satisfied, the processing returns to step S24.

(S28) The payoff calculation unit 123 uses the converged average payoff to update the payoff of the strategy of the present player selected in step S22. When the strategy selected in step S22 is not included in the population of the previous generation, the payoff after updating is an average payoff calculated through simulation. When the strategy selected in step S22 is included in the population of the previous generation, the payoff after updating is obtained by combining the average payoff described above and the payoff of the previous generation using the weighting w.

(S29) The payoff calculation unit 123 determines whether every individual included in the latest population c has been selected. When every individual has been selected, the processing proceeds to step S30, and when there are unselected individuals in the population c, the processing returns to step S22.

(S30) The population updating unit 125 determines whether the number of generations of the population has reached a predetermined upper limit on the number of generations. When the number of generations has reached the upper limit on the number of generations, the processing proceeds to step S31, and when the number of generations has not reached the upper limit on the number of generations, the processing returns to step S17.

(S31) The probability distribution calculation unit 124 updates the probability of each strategy included in the latest population c based on the individual payoffs and the average payoffs. The population updating unit 125 regards the latest probability distribution of the strategies included in the population c as the equilibrium solution for the probability distribution of the mixed strategies and outputs the probability distribution. The population updating unit 125 may display the probability distribution of the mixed strategies on the display apparatus 111, may store the probability distribution in non-volatile storage, and/or may transmit the probability distribution to another information processing apparatus.

As described above, the information processing apparatus 100 according to the second embodiment calculates the equilibrium solution for a probability distribution of mixed strategies created as a result of rational decision-making by a plurality of players. By doing so, useful information for analyzing a complex social system and institutional design is generated.

The information processing apparatus 100 approximates the probability distribution of mixed strategies using the population of a genetic algorithm. The information processing apparatus 100 calculates the payoffs of the strategies included in the population according to the latest probability distribution, and culls and breeds individuals included in the population based on the calculated payoffs. The information processing apparatus 100 also stochastically adds a small number of new strategies to the population by crossover, mutation, and random addition.

Payoffs are calculated only for strategies that are included in the latest population. This means that compared to replicator dynamics where the payoff of every strategy is calculated in all generations, there is a reduction in the calculation load of the simulation and the calculation time is shortened. Since a small number of new strategies are added in each generation, some opportunity is provided to consider new strategies aside from the narrowed-down strategies. As a result, a solution that approximates replicator dynamics with high accuracy is calculated.

In addition, when generating the first generation population, as a general rule the information processing apparatus 100 obtains the probabilities by calculating the payoff of every strategy. By doing so, the risk of a preferred strategy not being included in the first generation population is reduced, convergence of the equilibrium solution happens more quickly, and the accuracy of the equilibrium solution is improved. In addition to crossover and mutation, the information processing apparatus 100 adds new strategies to the population in each generation by random addition. This reduces the risk of new strategies not being produced and the number of strategies becoming exceedingly low, which may occur when only crossover and mutation are used. As a result, there is a reduced risk of the probability distribution becoming unstable as the number of strategies falls.

The information processing apparatus 100 uses the learning rate lr to calculate weighted averages of probabilities corrected based on the payoffs and the probabilities in the previous generation. By doing so, sudden changes in the probability distribution are suppressed, which increases the likelihood of a highly accurate equilibrium solution being calculated. The information processing apparatus 100 also uses the weighting w to calculate weighted averages of the payoffs calculated by the simulation and the payoffs of the previous generation. By doing so, the influence of other players’ strategies and random numbers selected in simulations performed in past generations is carried over to a certain extent into the latest payoffs. As a result, haphazardness is suppressed for the payoffs calculated by the simulation, and highly reliable payoffs are calculated.

In addition, when calculating the payoff of a certain strategy, the information processing apparatus 100 selects other players’ strategies from the population before new strategies are added. New strategies will not have been evaluated by the payoff function and their probabilities will have low reliability. For this reason, noise in the calculation of payoffs is reduced by using a population from before the new strategies are added.

According to one aspect, the present embodiments are able to reduce the load of calculating evaluation values in a search for an equilibrium solution.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable recording medium storing therein a computer program that causes a computer to execute a process comprising:
generating a data set including a plurality of records each of which indicates one out of a plurality of behaviors;
calculating a first evaluation value for each of at least two first behaviors, which is included in the plurality of behaviors and appears in the data set, based on a distribution of appearance frequency of the at least two first behaviors in the data set;
updating at least a part of the plurality of records included in the data set so as to increase an appearance frequency of a first behavior whose first evaluation value exceeds a threshold; and
calculating a second evaluation value for each of at least two second behaviors, which is included in the plurality of behaviors and appears in the updated data set, based on a distribution of appearance frequency of the at least two second behaviors in the updated data set.

2. The non-transitory computer-readable recording medium according to claim 1,
wherein the updating of at least a part of the plurality of records includes deleting at least a part of first behaviors whose first evaluation values are lower than the threshold from the data set.

3. The non-transitory computer-readable recording medium according to claim 1,
wherein the updating of at least a part of the plurality of records includes adding a new behavior, which is included in the plurality of behaviors but does not appear in the data set, to the data set.

4. The non-transitory computer-readable recording medium according to claim 3,
wherein the process further comprises determining an appearance frequency after updating of each of the at least two second behaviors, based on a first appearance frequency before the adding of the new behavior, a second appearance frequency after the adding of the new behavior, and the second evaluation value.

5. The non-transitory computer-readable recording medium according to claim 1,
wherein the calculating of the second evaluation value includes calculating the second evaluation value for a second behavior, which is the same as one out of the at least two first behaviors, by additionally using the first evaluation value.

6. A method of searching for an equilibrium solution comprising:
generating, by a processor, a data set including a plurality of records each of which indicates one out of a plurality of behaviors;
calculating, by the processor, a first evaluation value for each of at least two first behaviors, which is included in the plurality of behaviors and appears in the data set, based on a distribution of appearance frequency of the at least two first behaviors in the data set;
updating, by the processor, at least a part of the plurality of records included in the data set so as to increase an appearance frequency of a first behavior whose first evaluation value exceeds a threshold; and
calculating, by the processor, a second evaluation value for each of at least two second behaviors, which is included in the plurality of behaviors and appears in the updated data set, based on a distribution of appearance frequency of the at least two second behaviors in the updated data set.

7. An information processing apparatus comprising:
a memory configured to store a data set including a plurality of records each of which indicates one out of a plurality of behaviors; and
a processor coupled to the memory and the processor configured to:
calculate a first evaluation value for each of at least two first behaviors, which is included in the plurality of behaviors and appears in the data set, based on a distribution of appearance frequency of the at least two first behaviors in the data set;
update at least a part of the plurality of records included in the data set so as to increase an appearance frequency of a first behavior whose first evaluation value exceeds a threshold; and
calculate a second evaluation value for each of at least two second behaviors, which is included in the plurality of behaviors and appears in the updated data set, based on a distribution of appearance frequency of the at least two second behaviors in the updated data set.
